(19) United States
(12) Patent Application Publication
(10) Pub. No.: US 2025/0195924 A1
(43) Pub. Date: Jun. 19, 2025

(54) ATMOSPHERIC PRESSURE COMPENSATION CONTROL SYSTEM FOR POWERED AIR-PURIFYING RESPIRATOR AND METHOD

(71) Applicant: CHANGZHOU SHINE SCIENCE & TECHNOLOGY CO. LTD., Changzhou (CN)

(72) Inventors: Liang CHEN, Changzhou (CN); Dong LIANG, Changzhou (CN); Zhuang LIU, Changzhou (CN)

(73) Assignee: CCHANGZHOU SHINE SCIENCE & TECHNOLOGY CO. LTD., Changzhou (CN)

(21) Appl. No.: 19/028,336

(22) Filed: Jan. 17, 2025

Related U.S. Application Data
(63) Continuation of application No. PCT/CN2024/135999, filed on Dec. 2, 2024.

(30) Foreign Application Priority Data
Dec. 18, 2023 (CN) 2023117480289

(51) Int. Cl. A62B 18/00; F04D 25/06; F04D 25/08; F04D 27/00

(52) U.S. Cl. CPC A62B 18/006; F04D 25/0673; F04D 25/08; F04D 27/004; F05D 2270/02; F05D 2270/03; F05D 2270/3015; F05D 2270/62; F05D 2270/706; F05D 2270/80

(57) ABSTRACT

The invention relates to respirator technology. in particular to an atmospheric pressure compensation control system for a powered air-purifying respirator and a method. The atmospheric pressure compensation control system comprises a main unit and a battery pack, wherein a waterproof breathable membrane is installed over a through hole formed in an outer shell of the main unit or the battery pack; A collection module inside the main unit or battery pack detects atmospheric pressure in real time, while the chamber contains conversion, comparison, and control modules. The conversion module converts atmospheric pressure into an electrical signal, which is then processed by the comparison module to calculate and compare the pressure difference with a standard. The control module adjusts the fan speed in real time based on the pressure difference to maintain a constant internal-external pressure differential, ensuring stable airflow and the normal operation of the respirator.

### CROSS-REFERENCE TO RELATED APPLICATIONS

The application claims priority to Chinese patent application No. 2023117480289, filed on Dec. 18, 2023, the entire contents of which are incorporated herein by reference.

### TECHNICAL FIELD

The invention relates to the technical field of respirators, in particular to an atmospheric pressure compensation control system for a powered air-purifying respirator and a method.

### BACKGROUND

The primary function of a powered air-purifying respirator (PAPR) is to create negative pressure at an air intake of a volute by the rotation of an impeller of a high-pressure centrifugal fan. This negative pressure generates a pressure difference with the outside air surrounding a filter cartridge, which pushes air through the filter cartridge. The filter cartridge then removes contaminants from the air, ultimately delivering clean air for users to breathe.

However, the air pressure outside the filter cartridge is influenced by factors such as altitude, temperature, and humidity. Under constant rotational speed of the high-pressure centrifugal fan, fluctuations in the actual atmospheric pressure can lead to variations in the pressure difference, which may cause airflow to be inconsistent and the air supply unstable, thereby compromising the respiratory protection safety of users.

### SUMMARY

The technical problem to be solved by the invention is to provide an atmospheric pressure compensation control system for a powered air-purifying respirator and a method, effectively addressing the issues present in the background art.

To achieve the above purpose, the technical scheme adopted by the invention is as follows. An atmospheric pressure compensation control system for a powered air-purifying respirator and a method are provided. The atmospheric pressure compensation control system comprises a main unit and a battery pack, wherein
at least one through hole is formed in an outer shell of the main unit or the battery pack, and a waterproof breathable membrane is installed over the through hole;
a collection module is arranged inside a chamber of the main unit or the battery pack, and the chamber of the main unit contains a conversion module, a comparison module and a control module;
the collection module performs real-time detection of an actual atmospheric pressure;
the conversion module receives the actual atmospheric pressure and converts a pressure signal into an electrical signal;
the comparison module receives the electrical signal, calculates a specific atmospheric pressure value under current environmental conditions, and compares the calculated current atmospheric pressure with a laboratory standard atmospheric pressure to output a pressure difference;
the control module dynamically adjusts a speed of a fan in real time based on the pressure difference to maintain a constant internal and external pressure differential of the respirator under different environmental conditions.

Further, a power supply circuit is arranged in the main unit, and the power supply circuit is connected with the battery pack, and is used for adjusting an output voltage of the battery pack to a proper value to supply power to each module.

Further, the electric signal comprises an analog signal, a digital signal or a communication signal.

Further, the control module is provided with a motor drive circuit inside, and a microcontroller in the main unit uses the motor drive circuit to adjust the speed of the fan in real time.

Further, the collection module comprises one or more atmospheric pressure sensors installed inside the chamber of the battery pack or the chamber of the main unit.

Further, a conditioning circuit is arranged in the conversion module, and the conditioning circuit is used for converting the pressure signal into the electrical signal.

Further, the conditioning circuit is integrated on the collection module.

The invention further provides a control method of the atmospheric pressure compensation control system for a powered air-purifying respirator, comprising the following steps:
controlling atmospheric pressure sensors to acquire an actual atmospheric pressure in real time;
converting an acquired atmospheric pressure signal through a conditioning circuit to obtain a corresponding electrical signal;
based on the electrical signal obtained through conversion, calculating a specific atmospheric pressure value under current conditions, and comparing the calculated current atmospheric pressure with a laboratory standard atmospheric pressure to output a pressure difference; and
dynamically adjusting, by a microcontroller, a speed of a fan in real time based on the pressure difference to maintain a constant internal and external pressure differential of the respirator under different environmental conditions.

Further, the microcontroller within the main unit controls a drive motor using a PID algorithm to manage the speed of the fan.

Further, an absolute value of the pressure difference is compared with a set pressure difference threshold to determine a target fan speed, and based on the target fan speed and a current atmospheric pressure compensation status within the respirator, the speed of the fan is dynamically adjusted in real time.

The beneficial effects of the invention are as follows. By detecting changes in the current atmospheric pressure, the invention adjusts the speed of a brushless motor (fan) to adapt to the current atmospheric environment. After overcoming the resistance of a filter (filter cartridge), it consistently provides customers with a continuous and stable airflow, effectively ensuring the normal operation of the respirator and the safety of users.

### BRIEF DESCRIPTION OF DRAWINGS

In order to more clearly explain the embodiments of the invention or the technical scheme in the prior art, the following will briefly introduce the drawings needed in the description of the embodiments or the prior art. Obviously, the drawings in the following description are only some embodiments of the invention. For those of ordinary skill in the art, other drawings can be obtained according to the provided drawings without paying creative labor.

FIG. 1 is a flowchart of an atmospheric pressure compensation control method for a powered air-purifying respirator;

FIG. 2 is a frame diagram of an atmospheric pressure compensation control system for a powered air-purifying respirator;

FIG. 3 is a functional diagram of a powered air-purifying respirator; and

FIG. 4 is a working principle diagram of a main unit control system.

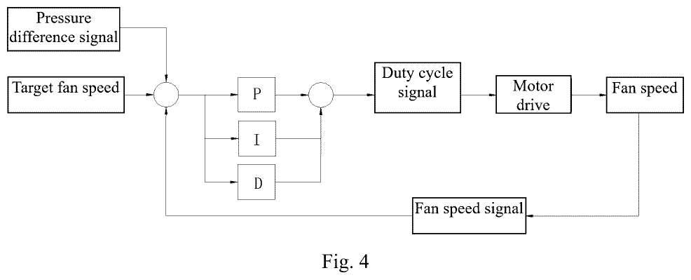

Reference numerals: 1. Main unit; 2. Battery pack; 3. Waterproof breathable membrane; 4. Power supply circuit; 5. Motor drive circuit; 6. Fan; 7. Microcomputer; 8. Atmospheric pressure sensor; 9. Conditioning circuit; 10. Filter.

### DETAILED DESCRIPTION OF THE EMBODIMENTS

The technical schemes in the embodiments of the present invention are clearly and completely described in the following with reference to the drawings in the embodiments of the present invention. It is obvious that the described embodiments are only some of the embodiments of the present invention and are not all the embodiments thereof.

It should be noted that when an element is described as being “fixed to” another element, it may be directly on another element or there may be an intermediate element. When an element is considered to be “connected” to another element, it may be directly connected to another element or there may be an intermediate element. The terms “vertical”, “horizontal”, “left”, “right” and similar expressions used herein are for the purpose of illustration only, and are not meant to be the only implementation way.

Unless otherwise defined, all technical terms and scientific terms used herein have the same meanings as commonly understood by those skilled in the technical field of the invention. The terms used in the specification of the invention are only for the purpose of describing specific embodiments. are not intended to limit the invention. As used herein, the term “and/or” includes any and all combinations of one or more related listed items.

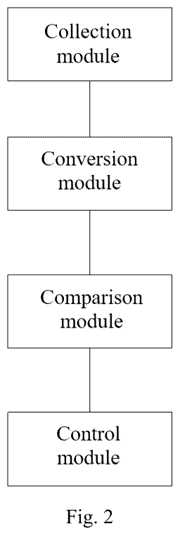

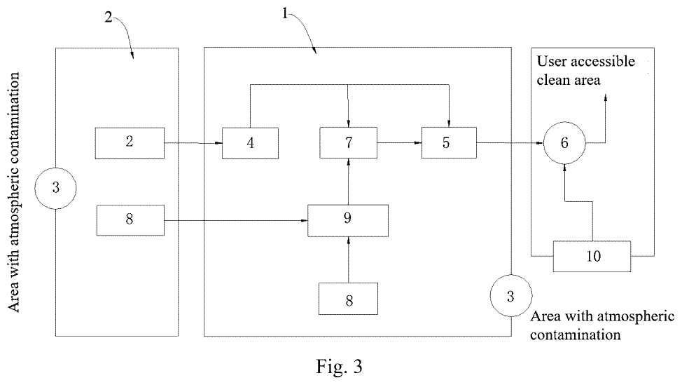

The invention provides an atmospheric pressure compensation control system for a powered air-purifying respirator, comprising a main unit 1 and a battery pack 2, wherein
at least one through hole is formed in an outer shell of the main unit 1 or the battery pack 2, and a waterproof breathable membrane 3 is installed over the through hole; as shown in FIGS. 2 and 3, a collection module is arranged inside a chamber of the main unit 1 or the battery pack 2, and the chamber of the main unit 1 contains a conversion module, a comparison module and a control module;
the collection module performs real-time detection of an actual atmospheric pressure;
the conversion module receives the actual atmospheric pressure and converts a pressure signal into an electrical signal; in the present invention, the electric signal comprises an analog signal, a digital signal or a communication signal;
the comparison module receives the electrical signal, calculates a specific atmospheric pressure value under current environmental conditions, and compares the calculated current atmospheric pressure with a laboratory standard atmospheric pressure to output a pressure difference; and
the control module dynamically adjusts a speed of a fan 6 in real time based on the pressure difference to maintain a constant internal and external pressure differential of the respirator under different environmental conditions.

In the present invention, the waterproof breathable membrane 3 is installed on the outer shell of the main unit 1 or battery pack 2, effectively preventing moisture and other impurities from entering the device while allowing air circulation. This setup facilitates the collection module in detecting the atmospheric pressure. Both the main unit 1 and the battery pack 2 are equipped with collection modules inside that accurately gather external pressure information, ensuring the reliability of detected data. The acquired atmospheric pressure is converted into the electrical signal, making it easier to process and transmit, thus facilitating subsequent calculation and control. The electrical signal is then converted back into a specific atmospheric pressure value for comparison with the laboratory standard atmospheric pressure, allowing for a more precise understanding of the current atmospheric conditions. This enables targeted real-time dynamic adjustment to the speed of the fan 6, ensuring that the respirator maintains an appropriate internal and external pressure differential in different environments, thus keeping the airflow constant. By detecting changes in the current atmospheric pressure, the invention adjusts the speed of a brushless motor (fan 6) to adapt to the current atmospheric environment. After overcoming the resistance of a filter 10 (filter cartridge), it consistently provides customers with a continuous and stable airflow, effectively ensuring the normal operation of the respirator and the safety of users.

In a preferred scheme of the invention, a power supply circuit 4 is arranged in the main unit 1, and the power supply circuit 4 is connected with the battery pack 2, and is used for adjusting an output voltage of the battery pack 2 to a proper value to supply power to each module. This design ensures that each module receives a stable and suitable voltage supply, thereby guaranteeing the normal operation of the entire system. By adjusting the output voltage of the battery pack 2, the different voltage requirements of various modules can be met, while effectively protecting each module from the effects of unstable or excessive voltage, extending the lifespan of the device and enhancing the reliability and stability of the system.

As a preferred implementation method, the control module is provided with a motor drive circuit 5 inside, and a microcontroller 7 in the main unit 1 uses the motor drive circuit 5 to adjust the speed of the fan 6 in real time. By adjusting the speed of the fan 6 in real time to compensate for changes in atmospheric pressure, a constant internal and external pressure differential can be maintained more precisely, ensuring the normal functionality of the respirator. For instance, when using the respirator in high-altitude areas, the speed of the fan 6 can be pre-adjusted according to the low pressure conditions at high altitudes to ensure that the respirator operates effectively. Additionally, through the control of the microcontroller, automated control of the respirator can be achieved. The speed of the fan 6 can be automatically adjusted based on preset parameters and environmental conditions, providing optimal ventilation performance.

In a preferred embodiment of the invention, the collection module comprises one or more atmospheric pressure sensors 8 installed inside the chamber of the battery pack 2 or the chamber of the main unit 1. By combining the atmospheric pressure sensors 8 with the control module and the motor drive circuit 5, automated control of the respirator is achieved, enabling real-time acquisition of atmospheric pressure data and automatic compensation, thus alleviating the operational burden for users and ensuring that the respirator is always in an optimal working condition.

As a preferred option of the above embodiment, a conditioning circuit 9 is arranged in the conversion module, and the conditioning circuit 9 is used for converting the pressure signal into the electrical signal. First, the conditioning circuit 9 amplifies the collected pressure signal to increase the amplitude and range of the signal, making it easier to measure and process. Furthermore, a filter is used to remove noise, spurious components, or other unnecessary frequency components from the signal to enhance the accuracy and stability of the signal. The conditioning circuit 9 also converts a nonlinear output signal of the atmospheric pressure sensors 8 into a linear response for more convenient subsequent processing and calculation. Finally, the conditioning circuit 9 rectifies the signal (using either full-wave or half-wave rectification) and selects an appropriate sampling method to obtain a stable and reliable electrical signal. In the present invention, the conditioning circuit 9, by employing amplification, filtering, and linearization during the conversion of the pressure signal to the electrical signal, provides a signal suitable for the subsequent system, offering advantages such as signal enhancement, noise removal, and adaptability. This ensures the accuracy and reliability of the pressure signal, laying a solid foundation for subsequent data processing and control.

In a preferred implementation method, the conditioning circuit 9 is integrated on the collection module. By closely integrating the conditioning circuit 9 with the sensors, the impact of external electromagnetic interference on the signal can be minimized, enhancing the anti-interference capability of the collection module and ensuring the accuracy and stability of the signal.

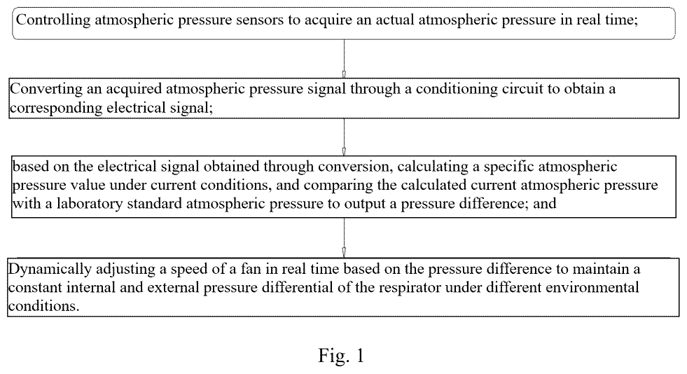

Refer to FIG. 1, the invention further provides a control method of the atmospheric pressure compensation control system for a powered air-purifying respirator, comprising the following steps:
controlling atmospheric pressure sensors 8 to acquire an actual atmospheric pressure in real time;
converting an acquired atmospheric pressure signal through a conditioning circuit 9 to obtain a corresponding electrical signal;
based on the electrical signal obtained through conversion, calculating a specific atmospheric pressure value under current conditions, and comparing the calculated current atmospheric pressure with a laboratory standard atmospheric pressure to output a pressure difference; and
dynamically adjusting a speed of a fan 6 in real time based on the pressure difference to maintain a constant internal and external pressure differential of the respirator under different environmental conditions.

In the atmospheric pressure compensation control method of this implementation scheme, the actual atmospheric pressure can be acquired in real time. By obtaining the pressure difference through calculation and comparison based on variations in atmospheric pressure under different environmental conditions, the system can automatically and timely adjust the speed of the fan 6. When the pressure difference increases, the microcontroller 7 increases the speed of the fan 6; and when the pressure difference decreases, the microcontroller 7 reduces the speed of the fan 6. Through real-time monitoring and adjustment, along with control by the microcontroller 7, automated adjustment of the speed of the fan 6 can be achieved, ensuring that the respirator consistently maintains a normal internal and external pressure differential under varying environmental conditions, thus enhancing the stability and reliability of the system.

In the specific implementation process, the microcontroller 7 within the main unit 1 controls a drive motor using a PID algorithm to manage the speed of the fan 6. The PID algorithm enables stable control performance under varying operating conditions, allowing for better response to changes in system parameters and external disturbances. This results in higher system stability. Moreover, the PID control algorithm has a good response speed, enabling rapid adjustment to the control output for quick tracking and regulation of the system, making it suitable for control scenarios with high real-time requirements.

As a more specific practice, as shown in FIG. 5, the microcontroller 7 compares an absolute value of the pressure difference with a set pressure difference threshold to determine a target fan speed, and based on the target fan speed and a current atmospheric pressure compensation status within the respirator, the speed of the fan 6 is dynamically adjusted in real time.

Specifically, the absolute value of the pressure difference calculated in the control method is compared with the set pressure difference threshold to determine whether the current atmospheric pressure compensation within the respirator meets the requirements. If the pressure difference exceeds the set pressure difference threshold, it indicates that the internal and external pressure differential of the respirator has surpassed an expected value. The target fan speed is then calculated based on the excess amount. Further evaluation is conducted to determine whether the respirator needs to increase or decrease pressure, allowing for adjustment to the speed of the fan 6 to control the airflow and maintain a constant internal and external pressure differential. By dynamically adjusting the speed of the fan 6 based on the target fan speed, the respirator can achieve an adaptive atmospheric pressure compensation function, ensuring stable operation under varying environmental conditions and guaranteeing user comfort and safety.

Those skilled in the art should understand that the invention is not limited by the above-mentioned embodiments. What is described in the above-mentioned embodiments and the description is only to illustrate the principles of the invention. Without departing from the spirit and scope of the invention, the invention will have various changes and improvements, which all fall within the scope of the claimed invention. The protection scope of the invention is defined by the appended claims and their equivalents.

What is claimed is:

1. An atmospheric pressure compensation control system for a powered air-purifying respirator, comprising a main unit and a battery pack, wherein
at least one through hole is formed in an outer shell of the main unit or the battery pack, and a waterproof breathable membrane is installed over the through hole;
a collection module is arranged inside a chamber of the main unit or the battery pack, and the chamber of the main unit contains a conversion module, a comparison module and a control module;
the collection module performs real-time detection of an actual atmospheric pressure;
the conversion module receives the actual atmospheric pressure and converts a pressure signal into an electrical signal;
the comparison module receives the electrical signal, calculates a specific atmospheric pressure value under current environmental conditions, and compares the calculated current atmospheric pressure with a laboratory standard atmospheric pressure to output a pressure difference;
the control module dynamically adjusts a speed of a fan in real time based on the pressure difference to maintain a constant internal and external pressure differential of the respirator under different environmental conditions;
the control module is provided with a motor drive circuit inside, and a microcontroller in the main unit uses the motor drive circuit to adjust the speed of the fan in real time, and is capable of automatically adjusting the speed of the fan based on preset parameters and environmental conditions; and
the collection module comprises one or more atmospheric pressure sensors installed inside the chamber of the battery pack or the chamber of the main unit, and by combining the atmospheric pressure sensors with the control module and the motor drive circuit, automated control of the respirator is achieved, enabling real-time acquisition of atmospheric pressure data and automatic compensation.

2. The atmospheric pressure compensation control system for a powered air-purifying respirator according to claim 1, wherein a power supply circuit is arranged in the main unit, and the power supply circuit is connected with the battery pack, and is used for adjusting an output voltage of the battery pack to a proper value to supply power to each module.

3. The atmospheric pressure compensation control system for a powered air-purifying respirator according to claim 1, wherein the electric signal comprises an analog signal, a digital signal or a communication signal.

4. The atmospheric pressure compensation control system for a powered air-purifying respirator according to claim 1, wherein a conditioning circuit is arranged in the conversion module, and the conditioning circuit is used for converting the pressure signal into the electrical signal.

5. The atmospheric pressure compensation control system for a powered air-purifying respirator according to claim 4, wherein the conditioning circuit is integrated on the collection module.

6. A control method of the atmospheric pressure compensation control system for a powered air-purifying respirator according to claim 1, comprising the following steps:
controlling atmospheric pressure sensors to acquire an actual atmospheric pressure in real time;
converting an acquired atmospheric pressure signal through a conditioning circuit to obtain a corresponding electrical signal;
based on the electrical signal obtained through conversion, calculating a specific atmospheric pressure value under current conditions, and comparing the calculated current atmospheric pressure with a laboratory standard atmospheric pressure to output a pressure difference; and
dynamically adjusting a speed of a fan in real time based on the pressure difference to maintain a constant internal and external pressure differential of the respirator under different environmental conditions.

7. The control method of the atmospheric pressure compensation control system for a powered air-purifying respirator according to claim 6, wherein a microcontroller within the main unit controls a drive motor using a PID algorithm to manage the speed of the fan.

8. The control method of the atmospheric pressure compensation control system for a powered air-purifying respirator according to claim 6, wherein an absolute value of the pressure difference is compared with a set pressure difference threshold to determine a target fan speed, and based on the target fan speed and a current atmospheric pressure compensation status within the respirator, the speed of the fan is dynamically adjusted in real time.
